(19) United States
(12) Patent Application Publication
(10) Pub. No.: US 2006/0221505 A1
(43) Pub. Date: Oct. 5, 2006

(54) Head actuator and information storage apparatus

(75) Inventors: Shinji Fujimoto, Itabashi (JP); Tsuneyori Ino, Yokohama (JP); Mitsuhiro Izumi, Yokohama (JP); Hiroshi Ishiyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/391,470

(22) Filed: Mar. 29, 2006

(30) Foreign Application Priority Data
Mar. 31, 2005 (JP) 2005-101873

(51) Int. Cl. G11B 5/55; G11B 21/08

(52) U.S. Cl. 360/264.7

(57) ABSTRACT

A head actuator that positions a head to perform information recording or playback on a computer readable storage medium, has a voice coil flanked by magnets. Through the voice coil a drive current flows and a damper to fit in a space between the voice coil and one of the magnets is formed on at least a portion of the voice coil. The head actuator vibration is controlled to achieve a more compact information storage apparatus and high-density recording. For example, on a voice coil (51) of a head actuator (20), a damping material (71) consisting of single layer viscoelasticity is formed along one lap of the voice coil (51). The damping material (71) is a single layer to not take up dimensions in the thickness direction, and, while pursuing making the apparatus more compact, it is possible to hold down vibration generated by the actuator (20).

### CROSS-REFERENCE TO RELATED APPLICATIONS

This application claims the benefit of Japanese Application No. 2005-101873, filed Mar. 31, 2005, in the Japan Patent Office, the disclosure of which is incorporated herein by reference.

### BACKGROUND OF THE INVENTION

1. Field of the Invention

The present invention relates to a head actuator structure that is built into an information storage apparatus and that positions a head that performs writing or reading of data with respect to a storage (recording) medium at the desired position on the storage (recording) medium.

2. Description of the Related Art

For example, a head actuator and a magnetic disk are incorporated into an information storage apparatus of which a hard disk drive apparatus (HDD) is representative. The head actuator rotates about a shaft and positions the head at the desired location of the magnetic disk. The head actuator is driven by a voice coil motor (VCM). The VCM is configured by voice coil that is attached to a magnetic circuit and a head actuator. The magnetic circuit is equipped with a pair of yokes and permanent magnets that are secured to the yokes. The permanent magnets are arranged in opposition facing either side of a gap. The voice coil is arranged in the gap. A magnetic flux is generated between the permanent magnets, and the magnetic flux cycles the two yokes. On the other hand, a magnetic flux is generated by means of an electric current flowing in the voice coil. Displacement of the voice coil is brought about by the interaction of the magnetic flux of the yokes and the magnetic flux of the voice coil, and rotation of the head actuator is caused.

FIG. 1 is a top view of the VCM. The head actuator 20 is rotatably mounted. Holders 52 and arms 22 that support the voice coil 51 are supported about the shaft of the head actuator 20. A head suspension 25 that supports a magnetic head 14 that performs information reading and writing with respect to a magnetic disk 11 is mounted on the arms 22. The magnetic circuit is configured by a pair of upper and lower yokes 53, 63 (the upper side has been omitted) comprising of magnetic materials and permanent magnets 55, 65 (the upper side has been omitted) secured to the respective upper and lower yokes 53, 63.

FIG. 2 is a rear side surface drawing of a common VCM. The permanent magnets 55, 65 secured to the pair of upper and lower yokes 53, 63 are divided into north poles and south poles interposing boundaries (neutral centers) 54, 64. The two permanent magnets, 55 and 65, are secured to the respective yokes, 53 and 63, so that the mutually different polarities are in opposition. That is, the two permanent magnets 55, 65 are secured to the yokes 53, 63 so that the interposing boundaries, 54 and 64, are aligned along the rotating shaft direction.

However, as shown in FIG. 3, the interposing boundaries, 54 and 64, of the permanent magnets 55, 65 come to have an offset in the circumferential direction due to, for example, yoke attachment error, permanent magnet dimensional error or error in yoke attachment. As a result, the magnetic flux that passed between the permanent magnets tilts, and a force in the direction along the rotating shaft that is normally not required is generated in the head actuator 20. That force vibrates the head actuator and causes head positioning accuracy to drop.

Conventionally, tilting of the magnetic flux has been controlled by raising the dimensional accuracy and the attachment accuracy of the magnetic circuit and the head actuator 20. However, as the track pitch of recording disks became narrower in order to achieve HDD high-density recording, even though vibrations were minute, the vibrations came to appear larger. There were limits to increasing the mechanical precision of the components, and countermeasures resulting from other means became necessary.

Therefore, vibration produced in the head actuator 20 must be restricted, and, in Japanese Unexamined Patent Application Publication 2003-22631, a structure is provided in which a damping material that is a laminated body with both a viscoelastic body layer and a restriction layer is provided to cover, including a centrum of, a voice coil, or is provided to cover the whole, including the centrum, of a voice coil section that has a bobbin and a voice coil. However, as progress was made in making HDDs more compact, the space between the voice coil and the permanent magnets became narrower, and it became difficult to arrange a damping material consisting of a multilayer structure of both a viscoelastic body layer and a restriction layer on the voice coil according to the conventional method.

### SUMMARY OF THE INVENTION

The present invention was devised while taking the above circumstances into account, and in unlimiting examples, its first purpose is the achievement of a high-density recording of the information storage apparatus, its second purpose is an increase in head positioning accuracy, its third purpose is restriction of actuator arm vibration, and its fourth purpose is pursuit of a more compact information storage apparatus.

Additional aspects and advantages of the invention will be set forth in part in the description which follows and, in part, will be obvious from the description, or may be learned by practice of the invention.

According to a first embodiment of the present invention, a head actuator is provided in which a single-layer damping material comprising of a viscoelastic body is formed on the voice coil. Due the fact that a damping material member whose mechanical characteristics differ from the head actuator 20 is attached on the voice coil 51, it is possible for vibration energy to be absorbed by those members. According to an aspect of the invention, even if vibration is generated in the head actuator, the vibration energy is absorbed by a damping material, and vibration is promptly dampened. In addition, the damping material can be a single layer, and ample space need not be ensured between the voice coil and the permanent magnets. For this reason, there is no obstruction to the information storage apparatus being made more compact efficiently.

According to a second embodiment of the present invention, a head actuator is provided in which a damping material is formed outside the region where an electric current that contributes to the driving force in the circumferential direction of the voice coil. In the same way as the first embodiment, even if vibration is produced in the head actuator, it is possible to damp it using a damping material. In the voice coil, the region in which an electric current that contributes to the driving force in the circumferential direction may be separated from the space flanked by the permanent magnets of the magnetic circuit. According to an aspect of the invention, if a damping material is formed outside a region in which an electric current contributes to the driving force in the circumferential direction, a distance between the voice coil and the permanent magnets need not be taken into account, and the degree of freedom of the shape of the damping material becomes higher. Therefore, it is possible for a thick damping material to be formed, and the vibration restriction effect can be improved. In addition, there is no susceptibility to the effects of making the apparatus more compact.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a top view of a VCM.

FIG. 2 is a rear side surface view of a VCM.

FIG. 3 is a rear side surface view of a VCM in which the boundaries of the permanent magnets are offset.

FIG. 4 is a top view of an HDD.

FIG. 5 is a rear oblique view of a head actuator, according to a first embodiment of the present invention.

FIG. 6 is a rear oblique view of a head actuator, according to a second embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

According to an aspect of the present invention, in a head actuator structure for a computer information storage apparatus, such as (without limitation) a hard disk drive (HDD), due to the fact that a damping material is attached or arranged or present on the voice coil, for example, in a space between the voice coil and one of the permanent magnets, vibration of the head actuator can be controlled. For this reason, head positioning accuracy improves, and high-density recording is made possible. In addition, according to an aspect of the present invention, a VCM with a high mechanical accuracy in which tilting of the magnetic flux is not generated may not be necessary. For this reason, reduction of component costs can also be pursued. In addition, according to a first embodiment of the present invention, the damping material is a single layer, so it is thin. For this reason, it is possible to pursue making the computer information storage apparatus more compact. According to second embodiment of the present invention, there is no need to form a damping material in the space between the voice coil and the permanent magnets. For this reason, a thick damping material can be tolerated, and improvement of the vibration restriction effect can be pursued.

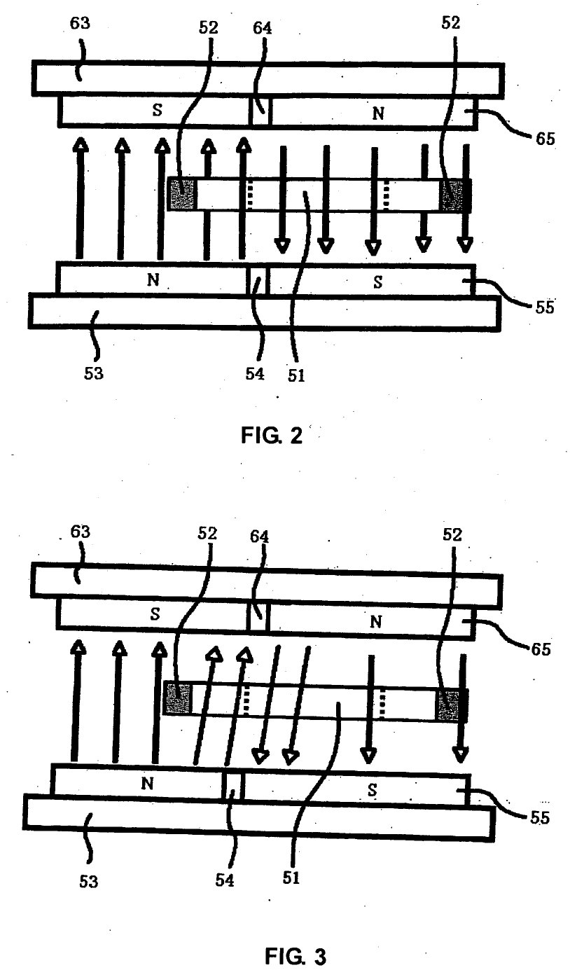

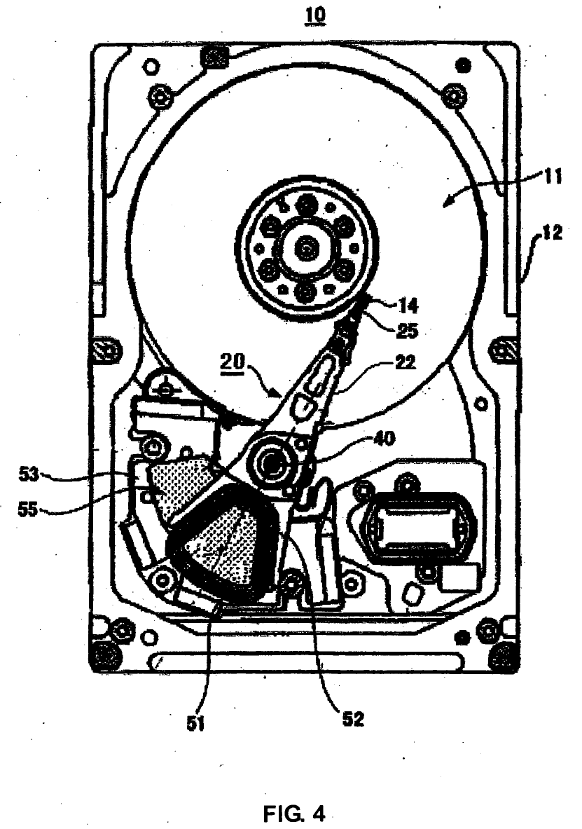

FIG. 4 is a top view of the HDD 10 with the cover (not shown in the drawing) removed. The magnetic disk 11 and the head actuator 20 are rotatably mounted on a base 12. Holders 52 that hold the voice coil 51 and a plurality of arms 22 are supported on the rotating shaft 40 of the head actuator 20. A head suspension 25 which has a magnetic head 14 attached thereto is mounted on the arms 22. The magnetic head 14 moves in the radial direction on the magnetic disk 11 and performs reading and writing of information with respect to the recording plane to which the magnetic disk 11 corresponds. A magnetic circuit is configured by permanent magnets 65 (see FIG. 2), 55, respectively secured to a pair of upper and lower yokes 63 (see FIG. 2), 53, and the VCM is configured along with the voice coil 51. In the present invention, a special feature is the fact that a damping material is attached onto the voice coil 51, and an explanation of the various embodiments is given below.

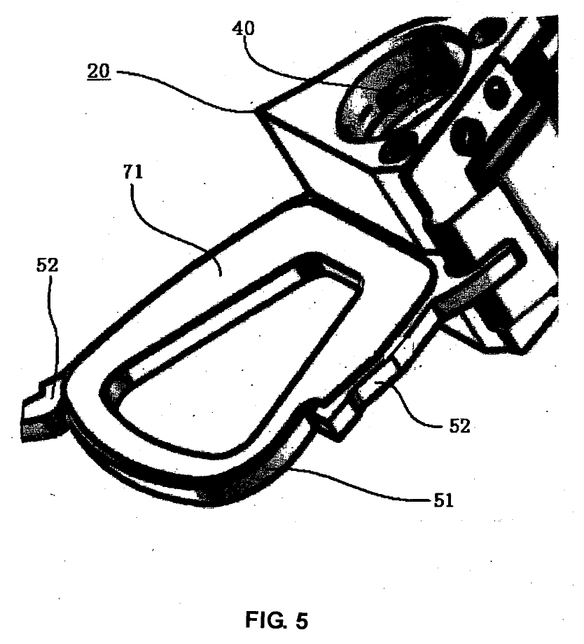

FIG. 5 is a rear oblique angle view of a head actuator, according to a first embodiment of the present invention. In the first embodiment, a single-layer damping material (single layer damper) 71 comprising of a viscoelastic body is formed across one lap on a top side surface of the voice coil 51. Typically, the voice coil 51 is interposed by the holders 52, and is secured to the holders 52 by a bonding agent.

The voice coil 51 is arranged in a region flanked by the permanent upper and lower magnets, 55 and 65 (see FIG. 2). A plurality of arms 22 (see FIG. 4) and holders 52 are molded as a unit and are formed by a metal, such as aluminum, or a resin, such as plastic. Here, typically, the damping material 71 is a material whose mechanical properties are different from the arms 22 and the holders 52, and it might be particularly necessary to make it from a material that is less rigid than these. For example, if the arms 22 and the holders 52 are formed by a resin, a damping material 71 also formed of resin should have different rigidity from the resin of the arms 22 and the holders 52. An acrylic pressure sensitive adhesive (e.g., soft and adhesive type material), or a resin bonding agent, can be used as the material that forms the damping material 71. The damping material 71 may be secured onto the voice coil 51 using adhesive strength or, if the viscosity is low, it may be painted on.

According to an aspect of the first embodiment of the present invention, the damping material 71 damps the vibration of the head actuator 20. High positional accuracy can be maintained, contributing to high-density recording. In addition, typically, the damping material 71 is formed along one lap (any lap on the voice coil 51, for example, upper lap, lower lap, interior lap, or exterior lap, or any combinations thereof in whole or in parts/portions/segments) of the voice coil, but since the single layer damper 71 is a single layer, a wide space is not needed between the permanent magnets 55, 65, such that the single layer damper 71 can be provided in a compact computer information storage apparatus. Therefore, the single layer damper 71 contributes to making the HDD more compact. According to an aspect of the present invention, the damping material 71 can be formed along an upper lap, or a lower lap, or any combinations thereof, of a voice coil of a VCM, but since the damping material 71 is a single layer on a lap of the voice coil 51, a wide space may not be needed between permanent magnets 55, 65 of the VCM.

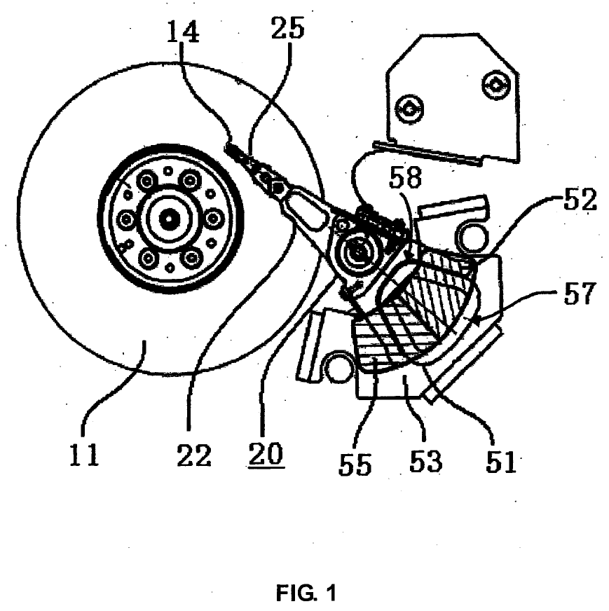

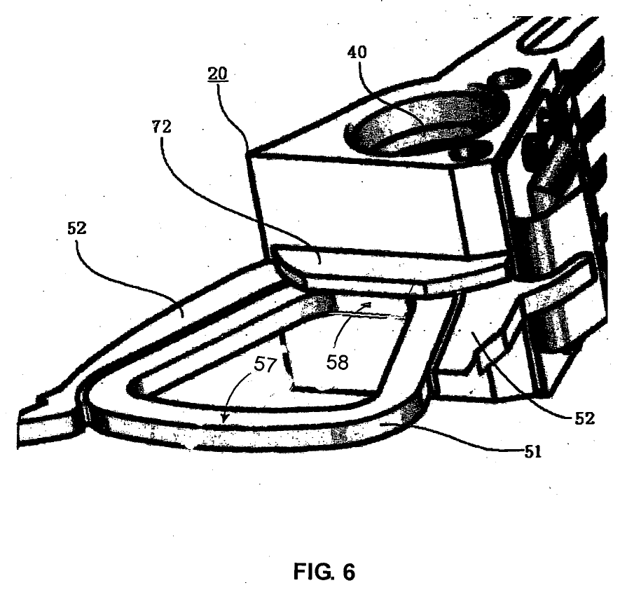

FIG. 6 is a rear oblique angle view of a head actuator, according to a second embodiment of the present invention. In the second embodiment, a damping material is provided on a part of a voice coil 51 where the electric current flows through but does not contribute to driving in the circumferential direction of the head actuator 20 (or damping material is provided outside a region where an electric current contributes to the driving force in the circumferential direction of the voice coil 51), or a damping material is provided on a part of a voice coil 51 that does not need to be present in a space between permanent magnets 55, 65. In the second embodiment, for example, a damping material 72 is formed on a part of a top side surface of the voice coil 51. The voice coil 51 is arranged in a space flanked by the permanent magnets, 55 and 65 (see FIG. 2). Typically, the voice coil 51 is such that coil pieces 57 and 58 are present that extend around the rotating shaft 40 and outside a space flanked by the permanent magnets 55 and 65 of the VCM (See also FIG. 1). The electric current that flows through these coil pieces 57, 58 does not contribute to driving in the circumferential direction of the head actuator 20, and these coil pieces 57, 58 do not need to be present in the space between permanent magnets 55 and 65. In the second embodiment, a damping material 72 can be formed on the surface of coil piece 58 of the inner circumference side, or on the surface of coil piece 57 of the outer circumference side, or any combinations thereof. In the same way as the first embodiment, a plurality of arms 22 and holders 52 are formed as a unit and are formed by a metal, such as aluminum, or a resin, such as plastic.

More particularly, in the second embodiment, the damping material 72 is formed at a location that is separated from the space flanked by permanent magnets 55 and 65 of a VCM. Therefore, it does not tend to be subject to restrictions with respect to the dimensions (thickness) in the shaft direction, and it can be formed relatively thick. As with the first embodiment, the damping material 72 comprises of a member whose mechanical properties are different from those of the arms 22 and the holders 52. The damping material 72 may be a single layer or multiple layers. If the damping material 72 is a single layer, the same materials and formation method as in the first embodiment can be applied. If the damping material 72 is formed by multiple layers, for example, a laminated body with a viscoelastic body layer and a restriction layer that has higher rigidity than the viscoelastic body can be used, and the damping material comprising of the laminated body can be secured onto the voice coil using the adhesive strength of the viscoelastic body. That is, the viscoelastic body can be arranged on the voice coil side. According to an aspect of the invention, a structure in which a separate viscoelastic body layer is formed on the restriction layer and a restriction layer is interposed by viscoelastic body layers may also be adopted. As the material of the viscoelastic body layer, an acrylic pressure sensitive adhesive or a resin bonding agent, or any combinations thereof, can be used. As the material of the restriction layer, a material that has high rigidity and that is not susceptible to the effects of magnetic fields can be desirable, and non-magnetic metals, such as stainless steel and aluminum, or resins, such as polyimides, may be used, or any combinations thereof. According to an aspect of the present invention, a damping material 72, as a single layer or a multilayer structure (or any combinations thereof), can be formed on the surface of coil piece 58 of the inner circumference side, or on the surface of coil piece 57 of the outer circumference side, or any combinations thereof.

According to an aspect of the second embodiment, the damping material 72 damps the vibration of the head actuator. High positional accuracy can be maintained, and high-density recording is contributed to. In addition, the damping material 72 may also be formed at a position that is separated from the space that is flanked by the permanent magnets. Therefore, the thickness dimension restrictions are alleviated, which contributes to making the apparatus more compact. In addition, since the damping material 72 can be formed relatively thick, it is possible to compensate for the fact that the damping material formation surface shrinks. According to an aspect of the second embodiment, the damping material 72 can be applied to larger older HDDs.

According to an aspect of the aforementioned first and second embodiments, a plurality of arms 22 and holders 52 are molded as a unit, but the plurality of arms 22 and the holders 52 may also be respectively formed as separate members. In addition, the plurality of arms 22 may also be configured so that individual arm members are laminated along the rotating shaft 40. Also, in either of the first and second embodiments, the damping material 71, 72 may be formed on both surfaces of the voice coil, or it may be formed on only one of either the upper or lower surfaces, or any combinations thereof. In addition, the voice coil 51 is flanked by two holders 52, but its entire circumference may be surrounded by a holder, the holder may be given a flat plate shape, and the voice coil may be embedded in a slit formed in the holder. According to an aspect of the invention, a part of the damping materials 71, 72 can be provided on the holders 52 and another part thereof on the voice coil 51, all of the damping material 71, 72 can be provided on the voice coil 51, all of the damping material 71, 72 can be provided on the holders 52, or any combinations thereof. According to an aspect of the present invention, the damping material 71 can cover all surfaces of a portion of the voice coil 51, or all of the voice coil 51, for example, via painting or dipping. According to an aspect of the present invention, the damping materials 71, 72 do not cover a center (centrum) of the voice coil 51.

According to an aspect of the present invention, a head actuator that positions a head that performs information recording or playback in the desired position on a storage medium is characterized in that it has a voice coil through which a drive current flows and a single-layer damping material that comprises of a viscoelastic body formed on said voice coil. According to an aspect of the present invention, the voice coil rotates about a shaft, and said damping material is formed on a surface that is parallel to the plane of rotation of said voice coil. According to an aspect of the invention, said damping material is formed across one lap in the winding direction of said voice coil.

According to an aspect of the invention, a head actuator that positions a head that rotates about a shaft and performs information recording or playback in the desired position on the storage medium is characterized in that it has a voice coil through which a drive current flows and a damping material formed on said voice coil, and said damping material exists outside the region where an electric current flows that contributes to the generation of a driving force in the circumferential direction. According to an aspect of the invention, said damping material is formed in a region along the circumferential direction of the rotation in said voice coil. According to an aspect of the invention, said damping material comprises a laminated structure of a viscoelastic body layer and/or a restriction layer.

According to an aspect of the invention, an information storage apparatus is characterized in that it has a head actuator that positions a head that rotates about a shaft and performs information recording or playback in the desired position on said storage medium and a voice coil through which a drive current flows, and a single layer damping material comprising a viscoelastic body is formed on said voice coil. According to an aspect of the invention, said voice coil rotates about a shaft, and said damping material is formed on a surface that is parallel to the plane of rotation of said voice coil. According to an aspect of the invention, said damping material is formed along one lap in the winding direction of said voice coil.

According to an aspect of the invention, an information storage apparatus is characterized in that it has a head actuator that is supported so that it rotates freely about a shaft and positions a head that performs information recording or playback in the desired position on said storage medium and a voice coil through which a drive current flows, a damping material is formed on said voice coil, and said damping material is present outside the region where an electric current flows that contributes to the generation of driving force in the circumferential direction. According to an aspect of the invention, the magnetic storage apparatus has a magnetic circuit that is equipped with a pair of opposing permanent magnets interposing said voice coil, and said damping material is arranged outside the magnetic flux created by the said permanent magnets. According to an aspect of the invention, said damping material comprises a laminated structure of a viscoelastic body layer and/or a restriction layer.

According to an aspect of the present invention, a head actuator structure embodying any combination of the first and second embodiments can be provided. According to an aspect of the invention, thinness or thickness of the dampers 71, 72 can depend on a size of the information storage apparatus, in particular, a size of a VCM, so that typically, the larger the VCM, the thicker can the dampers 71, 72. According to an aspect of the present invention, head actuator vibration is controlled and a more compact information storage apparatus and high-density recording is achieved. A head actuator that positions a head to perform information recording or playback on a computer readable storage medium, has a voice coil flanked by magnets. Through the voice coil a drive electric current flows and a damper to fit in a space between the voice coil and one of the magnets is formed on at least a portion of the voice coil. According to an aspect of the present invention, the damping material damps vibration and/or sound.

For example, on a voice coil 51 of a head actuator 20, a damping material 71, for example, consisting of a single layer viscoelasticity, or only a viscoelastic body, is formed, attached, arranged, present, on and/or above the voice coil 51 itself (directly on and/or above the voice coil 51), for example, along one or more laps or portions thereof of the voice coil 51. In this example, the damping material 71 is a single layer, such that the damping material does not take up dimensions in a thickness direction. According to an aspect of the present invention, with the single layer damping material 71, while pursuing to make the information storage apparatus more compact, it is possible to hold down vibration generated by the actuator 20. According to an aspect of the present invention, a single layer damper 71 arranged on at least one or more portions of the voice coil controls a tilting of a magnetic flux in a head actuator of a computer information storage apparatus. According to an aspect of the present invention, the single layer damping material 71 comprises a viscoelastic body layer, a resin, an acrylic pressure sensitive adhesive, a polyimide, a resin bonding agent, a material that has high rigidity and not susceptible to effects of magnetic fields, a non-magnetic metal, stainless steel, or aluminum, or any combinations thereof forming a single layer.

For example, according to an aspect of the invention, the damper 72 is present on a part of the voice coil outside a region where the electric current flows through the voice coil to contribute to generation of a driving force in a circumferential direction. The damper 72 is present on a surface of a voice coil piece of an inner circumference side, or on a surface of a voice coil piece of an outer circumference side, or any combinations thereof, outside a magnetic flux created by the magnets. The damper 72 can be made of the damper 71 material, for example, a single layer viscoelastic body, or a multilayer body with a viscoelastic body layer and a restriction layer. A thickness of the damper 72 can be equal to or larger than the space between the coil and the magnets.

According to an aspect of the invention, an information storage apparatus with a head actuator structure comprising the dampers 71 and 72, can be provided, for example, in a server system with an information storage apparatus of high rotation speed, fast access and middle capacity and/or in a laptop or portable computer/computing device.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A head actuator that positions a head that performs information recording or playback at a desired position on a storage medium, comprising:
a voice coil through which a drive current flows; and
a single-layer damping material consisting of a viscoelastic body formed on said voice coil.

2. A head actuator that positions a head that rotates about a shaft and performs information recording or playback at a desired position on a storage medium, comprising:
a voice coil through which a drive current flows; and
a damping material formed on said voice coil, and said damping material is present outside a region where an electric current flows that contributes to generation of a driving force in a circumferential direction.

3. An information storage apparatus, comprising:
a recording medium,
a head actuator that positions a head that performs information recording or playback at a desired position on said storage medium, and
a voice coil through which a drive current flows, and
a single layer damping material consisting of a viscoelastic body formed on said voice coil.

4. An information storage apparatus, comprising:
a recording medium,
a head actuator that positions a head supported so that the head rotates freely about a shaft and that performs information recording or playback at a desired position on said storage medium, and
a voice coil through which a drive current flows, and
a damping material formed on said voice coil outside a region where an electric current flows that contributes to generation of a driving force in a circumferential direction.

5. The information storage apparatus according to claim 4, further comprising:
a magnetic circuit that is equipped with a pair of opposing permanent magnets that face either side of said voice coil, and said damping material is arranged outside a magnetic flux created by said permanent magnets.

6. The information storage apparatus according to claim 4, wherein the damping material is present on a surface of a voice coil piece of an inner circumference side, or on a surface of a voice coil piece of an outer circumference side, or any combinations thereof, outside the region where the electric current flows that contributes to the generation of the driving force in the circumferential direction.

7. The information storage apparatus according to claim 4, wherein the damping material is a single layer viscoelastic body, or a multilayer body with a viscoelastic body layer and a restriction layer.

8. The head actuator according to claim 1, wherein the voice coil rotates about a shaft and said single layer damping material is formed on a surface of the voice coil that is parallel to a plane of rotation of said voice coil.

9. The head actuator according to claim 1, wherein said single layer damping material is arranged across one lap in a winding direction of said voice coil.

10. The head actuator according to claim 1, wherein the single layer damping material comprises a viscoelastic body layer, a resin, an acrylic pressure sensitive adhesive, a polyimide, a resin bonding agent, a material that has high rigidity and not susceptible to effects of magnetic fields, a non-magnetic metal, stainless steel, or aluminum, or any combinations thereof forming a single layer.

11. The head actuator according to claim 1, wherein the single layer damping material is secured onto the voice coil using adhesive strength, or painted on the voice coil, or any combinations thereof.

12. The information storage apparatus according to claim 3, wherein the voice coil rotates about a shaft and said single layer damping material is formed on a surface of the voice coil that is parallel to a plane of rotation of said voice coil.

13. The information storage apparatus according to claim 3, wherein said single layer damping material is arranged across one lap in a winding direction of said voice coil.

14. The information storage apparatus according to claim 3, wherein the single layer damping material is secured onto the voice coil using adhesive strength, or painted on the voice coil, or any combinations thereof.

15. The information storage apparatus according to claim 3, wherein the single layer damping material comprises a viscoelastic body layer, a resin, an acrylic pressure sensitive adhesive, a polyimide, a resin bonding agent, a material that has high rigidity and not susceptible to effects of magnetic fields, a non-magnetic metal, stainless steel, or aluminum, or any combinations thereof forming a single layer.

16. A head actuator that positions a head to perform information recording or playback on a computer readable storage medium, comprising:
a voice coil flanked by a pair of magnets and through the voice coil a drive electric current flows; and
a damper to fit in a space between the voice coil and one of the magnets and provided on at least a portion of the voice coil.

17. The head actuator according to claim 16, wherein the damper is a single layer viscoelastic body.

18. The head actuator according to claim 16, wherein the damper is a material of high rigidity that is not susceptible to effects of a magnetic field, a non-magnetic metal, stainless steel, or aluminum, or any combinations thereof.

19. The head actuator according to claim 16, further comprising:
holders to hold the voice coil and a plurality of arms, are supported on a rotating shaft of the head actuator,
wherein the damper is a material whose mechanical properties differ from the holders and the arms.

20. The head actuator according to claim 16, wherein the damper is formed across one lap in a winding direction of said voice coil, or across one lap on a surface parallel to a plane of rotation of said voice coil, or any combinations thereof.

21. The head actuator according to claim 16, wherein the damper is present on a part of the voice coil outside a region where the electric current flows through the voice coil to contribute to generation of a driving force in a circumferential direction.
